(19) United States
(12) Patent Application Publication
(10) Pub. No.: US 2014/0332632 A1
(43) Pub. Date: Nov. 13, 2014

(54) ISOLATION OF PAYLOAD FROM LAUNCH VEHICLE DYNAMIC LOADS

(71) Applicant: Space Systems/Loral, LLC, Palo Alto, CA (US)

(72) Inventors: Robert E. Helmer, Pleasanton, CA (US); Hauke G. Nehrenheim, San Jose, CA (US)

(73) Assignee: Space Systems/Loral, LLC, Palo Alto, CA (US)

(21) Appl. No.: 14/099,674

(22) Filed: Dec. 6, 2013

Related U.S. Application Data
(60) Provisional application No. 61/822,210, filed on May 10, 2013.

(51) Int. Cl. B64G 1/64

(52) U.S. Cl. CPC B64G 1/641
USPC 244/173.2

(57) ABSTRACT

An adapter arrangement includes a first adapter ring for interfacing with a launch vehicle payload interface ring, a second adapter ring for interfacing with a payload launch vehicle interface ring, and a plurality of vibration isolation devices disposed between and attached to each of the first adapter ring and the second adapter ring. The first adapter ring has a first standard interface with the launch vehicle payload interface ring and the second adapter ring has a second standard interface with the payload launch vehicle interface ring.

### CROSS-REFERENCE TO RELATED APPLICATIONS

This disclosure claims priority under 35 U.S.C. §119 to U.S. Provisional Patent Application No. 61/822,210, filed May 10, 2013, entitled “ISOLATION OF PAYLOAD FROM LAUNCH VEHICLE DYNAMIC LOADS,” and assigned to the assignee hereof. The disclosures of the prior application are considered part of, and are incorporated by reference in, this disclosure for all purposes.

### TECHNICAL FIELD

This invention relates generally to a mechanical interface adapter between a launch vehicle and a payload and, in particular, to an adapter that dampens dynamic launch loads while preserving a heritage payload attachment and separation interface.

### BACKGROUND OF THE INVENTION

The assignee of the present invention designs and manufactures spacecraft for communications and broadcast services. Structures of such spacecraft commonly include a structural interface ring (the “payload launch vehicle interface ring”) which mates to a launch vehicle adapter ring (the “launch vehicle payload interface ring”) by way of a v-band clamp that also serves as an attachment and separation system.

V-band clamps, also referred to as Marman clamps, are a type of band clamp widely used in industrial and aerospace applications to detachably join or affix adjacent structures to one another. Marman clamps for payload separation systems are described in “MARMAN CLAMP SYSTEM DESIGN GUIDELINES”, NASA Preferred Reliability Practices Guideline No. GDED-2214, (hereinafter, “NASA Guidelines”) the content of which is hereby incorporated by reference into the present application. Referring to FIG. 1, attachment and separation system 100 may include one or more band clamps (sometimes referred to as “straps”) 110 and tensioning devices 120. A number of V-segments (referred to herein as “shoes”) 130 are arranged on the interior surface of clamp 110. Attachment and separation system 100 is configured to encircle abutting cylindrical flanges on each of two parts that are affixed to each other. Tensioning device 120 may include a bolt or stud 122, nuts 124, and end fitting 126. Tensioning of band clamp 110 creates an inward radial restraining force on the shoes which in turn wedge together the abutting cylindrical flanges (i.e., 1001 and 1002) of the two parts to be joined in the axial direction. Where a first of the two parts to be joined is a launch vehicle, cylindrical flange 1001 may be referred to as the launch vehicle payload interface ring; where a second of the two parts to be joined is a payload, such as a spacecraft, for example, cylindrical flange 1002 may be referred to as the payload launch vehicle interface ring. Standard payload/launch vehicle interfaces as described above are costly to develop and qualify and there is a strong reluctance to allow changes to so-called “heritage” designs of same. Heritage design interface rings include those designed according to international standard adapter types 937B, 1194 and 1194A, for example.

Payloads are exposed, during launch, to dynamic loads transmitted from the launch vehicle to the payload by way of the attachment and separation system. Dampening devices that provide for the payload some isolation from the dynamic launch loads are known. For example, U.S. Pat. No., 7,249,756 to Wilke, et al., describes a passively damped vibration and shock load isolation apparatus. Known implementations, however, have required redesign and requalification of the payload/launch vehicle interface.

In light of the foregoing, techniques for dampening dynamic launch loads while preserving a standard payload attachment and separation interface are desirable.

### SUMMARY

The present disclosure contemplates an improved configuration of an adapter arrangement to be disposed between a spacecraft and a launch vehicle, the adapter arrangement being configured to dampen dynamic launch loads while permitting each of the spacecraft and the launch vehicle to retain a standard respective interface.

According to an implementation, an adapter arrangement includes a first adapter ring for interfacing with a launch vehicle payload interface ring, a second adapter ring for interfacing with a payload launch vehicle interface ring, and a plurality of vibration isolation devices disposed between and attached to each of the first adapter ring and the second adapter ring. The first adapter ring has a first standard interface with the launch vehicle payload interface ring and the second adapter ring has a second standard interface with the payload launch vehicle interface ring.

In another implementation the second standard interface may be an attachment and separation system. The attachment and separation system may include a Marman clamp.

In some implementations, the plurality of vibration isolation devices may include between 18 and 60 vibration isolation devices.

In some implementations, the vibration isolation devices may be passively damped vibration isolation mounts. The vibration isolation devices may be tunable uniflex or omniflex isolation devices. Alternatively, the vibration isolation devices may be non-tunable uniflex or omniflex isolation devices.

In an implementation, the second adapter ring may be separably attached to the payload launch vehicle interface ring. The second adapter ring may be separably attached to the payload launch interface ring by way of a Marman clamp.

In a further implementation one or both of the first standard interface and the second standard interface defines an 1194 mm adapter ring.

In an implementation a method for preparing a spacecraft to be launched on a launch vehicle includes disposing an adapter arrangement between the spacecraft and the launch vehicle. The adapter arrangement includes a first adapter ring for interfacing with a launch vehicle payload interface ring, a second adapter ring for interfacing with a payload launch vehicle interface ring, and a plurality of vibration isolation devices disposed between and attached to each of the first adapter ring and the second adapter ring. The first adapter ring has a first standard interface with the launch vehicle payload interface ring and the second adapter ring has a second standard interface with the payload launch vehicle interface ring.

### BRIEF DESCRIPTION OF THE DRAWINGS

Features of the invention are more fully disclosed in the following detailed description of the preferred embodiments, reference being had to the accompanying drawings, in which:

FIG. 1 illustrates an attachment and separation system according to the prior art.

FIG. 2 illustrates an adapter arrangement for dampening dynamic launch loads, according to an implementation.

FIG. 3 illustrates an example system implementation of an adapter arrangement together with a spacecraft, according to an implementation.

FIG. 4 illustrates a vibration isolation device, according to an implementation.

FIG. 5 illustrates an isometric conceptual view of a vibration isolation device, according to another implementation.

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### DETAILED DESCRIPTION

Specific exemplary embodiments of the invention will now be described with reference to the accompanying drawings. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element is referred to as being “connected” or “coupled” to another element, it can be directly connected or coupled to the other element, or intervening elements may be present. It will be understood that although the terms “first” and “second” are used herein to describe various elements, these elements should not be limited by these terms. These terms are used only to distinguish one element from another element. As used herein, the term “and/or” includes any and all combinations of one or more of the associated listed items. The symbol “I” is also used as a shorthand notation for “and/or”.

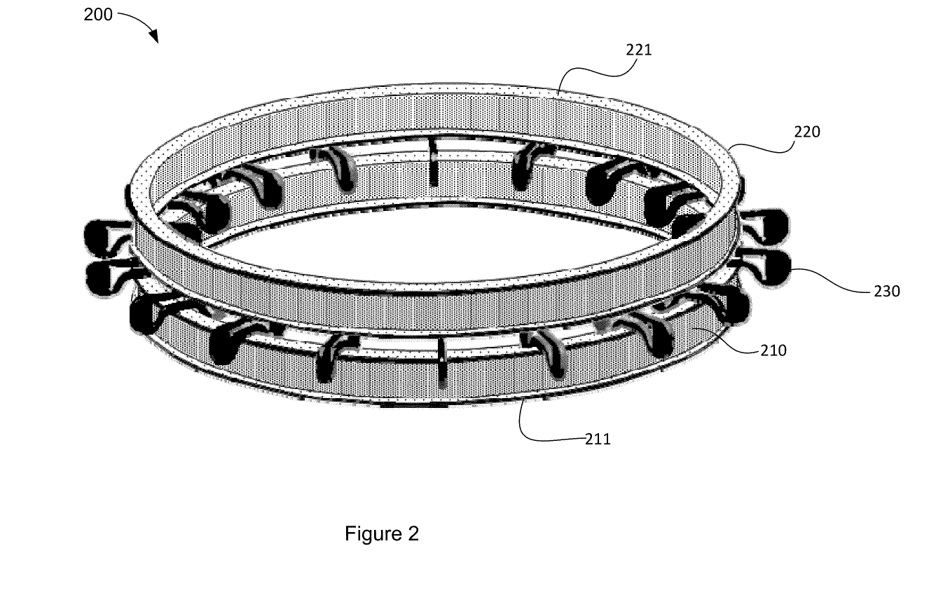

According to an embodiment of the presently disclosed techniques, an adapter that dampens dynamic launch loads while preserving a heritage payload attachment and separation interface is provided. Referring now to FIG. 2 adapter arrangement 200 may include first adapter ring 210 for interfacing with a launch vehicle payload interface ring (not illustrated) and second adapter ring 220 for interfacing with a payload launch vehicle interface ring (not illustrated). A number of vibration isolation devices 230 may be disposed between and attached to each of first adapter ring 210 and second adapter ring 230. Advantageously, first adapter ring 210 may have a standard interface 211 with the launch vehicle payload interface ring, whereas second adapter ring 220 may have a standard interface 221 with the payload launch vehicle interface ring.

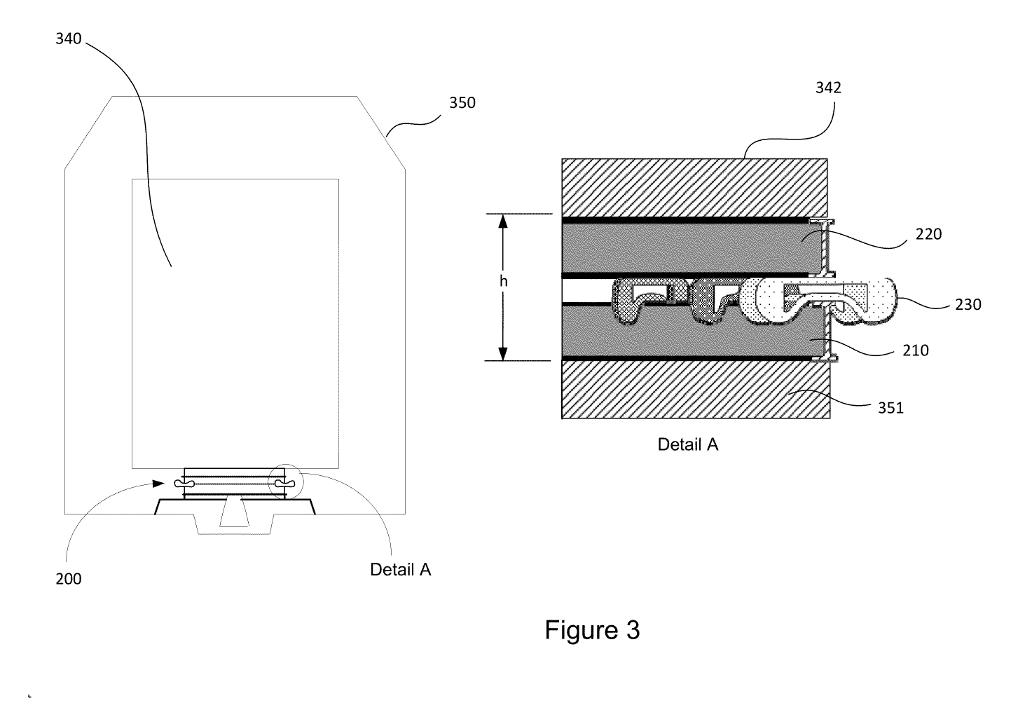

Referring now to FIG. 3, an example system implementation of adapter arrangement 200 together with spacecraft 340 within a fairing of launch vehicle 350 is illustrated. Spacecraft 340 may include payload launch vehicle interface ring 342. Launch vehicle 350 may include payload interface ring 351. Advantageously, payload launch vehicle interface ring 342 and launch vehicle payload interface ring 351 are standard, heritage, equipment. Adapter arrangement 200, as described hereinabove, may be disposed between launch vehicle interface ring 342 and payload interface ring 351.

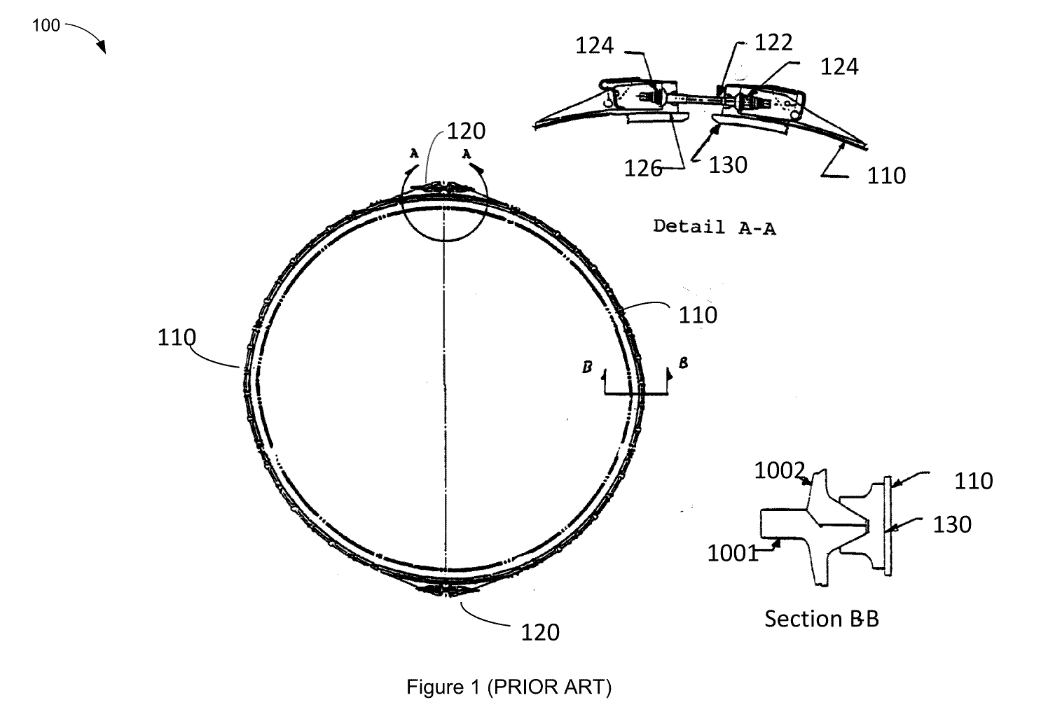

It will be appreciated that second adapter ring 220 may be separably attached to payload launch vehicle interface ring 342 by way of a heritage attachment and separation system 100 (illustrated in FIG. 1) as described hereinabove. Similarly, first adapter ring 210 may be separably attached to launch vehicle payload interface ring 351.

According to some implementations, stack height ‘h’ may be approximately 10 inches. Adapter arrangement 200 may have a mass of approximately 140 kg, for example.

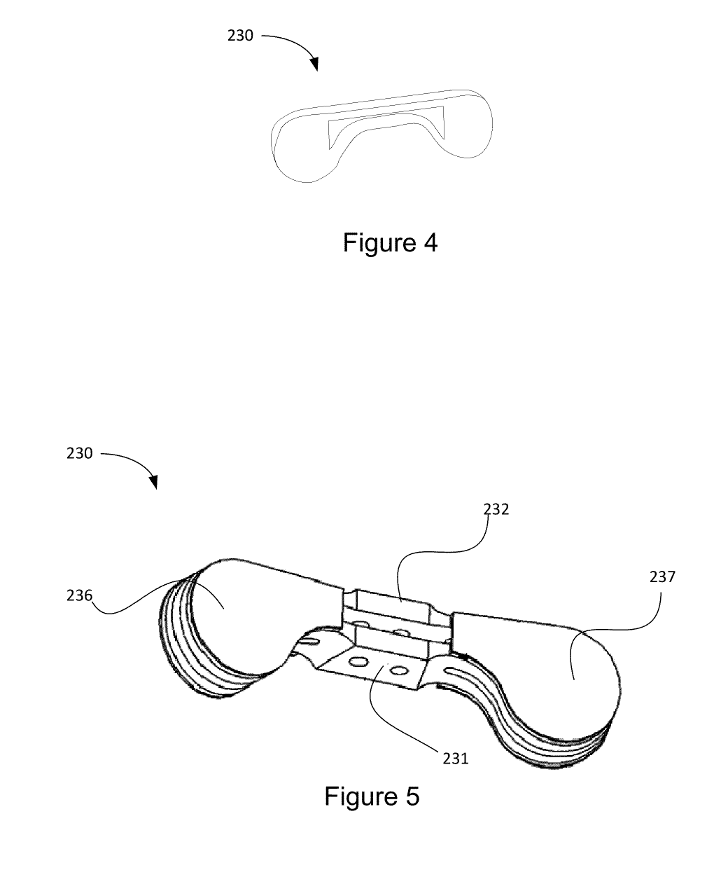

Referring now to FIG. 4, an implementation of vibration isolation device 230 is illustrated. In the illustrated implementation, vibration isolation device 230 is a passively damped vibration isolation mount of the type disclosed, for example in U.S. Pat. No. 7,249,756, the disclosure of which is hereby incorporated by reference into the present application in its entirety. Vibration isolation devices of other types may be contemplated. For example, tunable or non-tunable uniflex or omniflex isolation devices may be contemplated.

FIG. 5 illustrates an isometric conceptual view of vibration isolation device 230. Vibration isolation device 230 may include flexure elements 231, 232 disposed between loop flexures 236 and 237. Flexure elements 231 and 232 may include attachment means, for example bolt holes, by which vibration isolation device 230 may be attached to, respectively, first adapter ring 210 and second adapter ring 220. For example, flexure element 231 may be bolted to first adapter ring 210 and flexure element 232 may be bolted to second adapter ring 220.

As noted above, and illustrated in FIG. 2, a number of vibration isolation devices 230, may be disposed between first adapter ring 210 and second adapter ring 220. Together, isolation devices 230 may be configured to lower the frequency and amplitude of dynamic loads transmitted to the spacecraft from the launch vehicle during launch. In some implementations, between 18 and 60 vibration isolation devices 230 are contemplated. For example, an implementation with 54 vibration isolation devices 230 has been considered.

In an implementation, interface 211 of first adapter ring 210 and interface 221 of second adapter ring 220 meet standard launch vehicle adapter standards. For example, one or both interfaces may comply with a standard 1194 mm adapter interface. Advantageously, first adapter ring 210 may be attached to launch vehicle payload interface ring 351 by way of bolts or a non-separating band clamp, whereas second adapter ring 220 may be separably attached to payload launch vehicle interface ring 342 by way of a heritage attachment and separation system. As a result, upon deployment of the payload from the launch vehicle, adapter arrangement 200 stays with the launch vehicle.

It will be appreciated that the drawings illustrate simplified implementation concepts and certain components have been omitted for clarity. For example, in some implementations a heater system may be provided to maintain temperatures of flexure elements 232 within specified limits.

Thus, techniques for an adapter that dampens dynamic launch loads while preserving a heritage payload attachment and separation interface have been disclosed.

The foregoing merely illustrates principles of the invention. It will thus be appreciated that those skilled in the art will be able to devise numerous systems and methods which, although not explicitly shown or described herein, embody said principles of the invention and are thus within the spirit and scope of the invention as defined by the following claims.

What is claimed is:

1. An apparatus comprising:
a first adapter ring for interfacing with a launch vehicle payload interface ring;
a second adapter ring for interfacing with a payload launch vehicle interface ring;
a plurality of vibration isolation devices disposed between and attached to each of the first adapter ring and the second adapter ring; wherein
the first adapter ring has a first standard interface with the launch vehicle payload interface ring and the second adapter ring has a second standard interface with the payload launch vehicle interface ring.

2. The apparatus of claim 1 wherein the second standard interface is an attachment and separation system.

3. The apparatus of claim 2, wherein the attachment and separation system includes a Marman clamp.

4. The apparatus of claim 1, wherein the plurality of vibration isolation devices includes between 18 and 60 vibration isolation devices.

5. The apparatus of claim 1, wherein the vibration isolation devices are passively damped vibration isolation mounts.

6. The apparatus of claim 1, wherein the vibration isolation devices are tunable uniflex or omniflex isolation devices.

7. The apparatus of claim 1, wherein the vibration isolation devices are non-tunable uniflex or omniflex isolation devices

8. The apparatus of claim 1, wherein the second adapter ring is separably attached to the payload launch vehicle interface ring.

9. The apparatus of claim 8, wherein the second adapter ring is separably attached to the payload launch interface ring by way of a Marman clamp.

10. The apparatus of claim 1, wherein one or both of the first standard interface and the second standard interface defines an 1194 mm adapter ring.

11. A method for preparing a spacecraft to be launched on a launch vehicle, the method comprising:
disposing an adapter arrangement between the spacecraft and the launch vehicle, wherein the adapter arrangement comprises:
a first adapter ring for interfacing with a launch vehicle payload interface ring;
a second adapter ring for interfacing with a payload launch vehicle interface ring;
a plurality of vibration isolation devices disposed between and attached to each of the first adapter ring and the second adapter ring; wherein
the first adapter ring has a first standard interface with the launch vehicle payload interface ring and the second adapter ring has a second standard interface with the payload launch vehicle interface ring.

12. The method of claim 11 wherein the second standard interface is an attachment and separation system.

13. The method of claim 12, wherein the attachment and separation system includes a Marman clamp.

14. The method of claim 11, wherein the plurality of vibration isolation devices includes between 18 and 60 vibration isolation devices.

15. The method of claim 11, wherein the vibration isolation devices are passively damped vibration isolation mounts.

16. The method of claim 11, wherein the vibration isolation devices are tunable uniflex or omniflex isolation devices

17. The method of claim 11, wherein the vibration isolation devices are non-tunable uniflex or omniflex isolation devices

18. The method of claim 11, wherein the second adapter ring is separably attached to the payload launch vehicle interface ring.

19. The method of claim 18, wherein the second adapter ring is separably attached to the payload launch interface ring by way of a Marman clamp.

20. The method of claim 11, wherein one or both of the first standard interface and the second standard interface defines an 1194 mm adapter ring.
